(19) United States
(12) Patent Application Publication
(10) Pub. No.: US 2026/0329908 A1
(43) Pub. Date: Oct. 22, 2026

(54) MULTIVARIATE FACTOR PROCESSING OF INTERACTION DATA FOR IDENTIFYING INFORMATION DIVERGENCE

(71) Applicant: The Board of Regents of the University of Oklahoma, Norman, OK (US)

(72) Inventors: Arif Mohaimin Sadri, Norman, OK (US); Khondhaker Al Momin, Norman, OK (US)

(21) Appl. No.: 19/646,711

(22) Filed: Apr. 14, 2026

Related U.S. Application Data
(60) Provisional application No. 63/789,757, filed on Apr. 16, 2025.

(51) Int. Cl. G06F 16/334; G06F 16/387

(52) U.S. Cl. CPC G06F 16/334; G06F 16/387

(57) ABSTRACT

Examples for performing language processing from user interaction data for identifying information divergence. Examples include retrieving an original piece of online content and a related piece of online content from an online platform. Sentiment scores for the original and related content are determined using a natural language model, and a sentiment delta is calculated. A divergence assessment is performed by comparing the sentiment delta to a sentiment threshold value. If the sentiment delta exceeds the threshold, the related content is tagged as divergent. A notification associated with the divergent content is displayed on a user interface. The sentiment threshold value may be generated based on the original content or an event associated with the original content. The divergence assessment may also consider factors such as location, event data, and demographic information.

### CROSS-REFERENCE TO RELATED APPLICATIONS

This application claims priority to U.S. Provisional Patent Application No. 63/789,757, filed on Apr. 16, 2025, the entire disclosure of which is incorporated herein by reference.

### GOVERNMENT RIGHTS

This invention was made with government support under Grant No. CAREER-2339100 awarded by the National Science Foundation (NSF). The government has certain rights in the invention.

### BACKGROUND

Increasingly, people are relying on internet media sources over traditional media sources in various aspects of their lives, including entertainment, education, community, current events and news, and others. Specifically, social media platforms have been described as modern-day town squares, where people and organizations meet to share information, news, and opinions. Often, people go to social media for very specific reasons, such as engaging in conversations related to specific interests, or receiving up-to-date information on emergency situations, such as meteorological, geopolitical, or epidemic-related emergencies, for example, where accurate and efficient dispersion of information is critical.

### BRIEF DESCRIPTION OF THE DRAWINGS

The disclosed examples are described below with reference to the accompanying drawing figures listed below, wherein:

FIG. 1 illustrates an exemplary architecture that advantageously provides for measuring and identifying information divergence in online interactions;

FIG. 2 illustrates an exemplary online platform and associated interaction network of the architecture of FIG. 1;

FIG. 3 is a block diagram illustrating example operations for performing sentiment score calculations;

FIG. 4 is a block diagram illustrating example operations for performing information divergence assessments between online interactions;

FIG. 5 illustrates an example interaction network of an online platform including divergence indication information;

FIG. 6 is a block diagram illustrating example operations in performing factor assessment for online content;

FIGS. 7-10 illustrate example user interface displays for displaying divergence information;

FIG. 11 is a flowchart illustrating a method for measuring and identifying information divergence in online interactions;

FIG. 12 is a flowchart illustrating a method for performing factor assessment, such as for use in divergence assessment or for generating training data; and

FIG. 13 illustrates a block diagram of a computing device suitable for implementing various aspects of the disclosure.

The various examples will be described in detail with reference to the accompanying drawings. Wherever preferable, the same reference numbers will be used throughout the drawings to refer to the same or like parts. References made throughout this disclosure, relating to specific examples, are provided for illustrative purposes, and are not meant to limit all implementations or to be interpreted as excluding the existence of additional implementations that also incorporate the recited features.

### DETAILED DESCRIPTION

People turn to social media for very specific reasons that benefit from focused conversation themes, such as engaging in conversations related to specific interests, or receiving up-to-date information on emergency situations, such as meteorological, geopolitical, or epidemic-related emergencies, for example, where accurate and efficient dispersion of information is critical. Off-topic posting in these situations can lead to confusion and can limit the effectiveness of the accurate dispersion of information.

Disclosed herein are various systems and methods that address these known inefficiencies by identifying information divergence in online interactions. One such method includes retrieving an original piece of online content (POC) from a social media online platform, and additionally retrieving related POCs, such as replies to or reposts of the original POC, for example. The method also includes determining sentiment scores for the original and related POCs and further determining a sentiment delta between each related POC and the original POC. Based on a sentiment delta exceeding a threshold, the method includes determining that the related POC is a divergent POC comprising sentiment information divergent from sentiment information of the original POC. The related POC can then be tagged as a divergent POC and processed accordingly by the online platform. Thereby, the platform can identify, measure, and act upon POCs diverging too far from the scope of the original POC.

Examples of this disclosure automatically detect POCs out of scope from the context of other related POCs. Thereby, examples herein can automatically take actions related to the detected divergent POCs, such as labeling the POCs as divergent on the online platform so other users can be aware of the divergent nature of the POC, or removing the content from the associated online platform, such as if such content violates the terms of the online platform.

Examples of this disclosure can determine information based on multivariate analysis. Thereby, examples herein can consider more than the sentiment of a single POC, but can consider various other factors related to the account holders, such as the geographical location associated with the POCs, the timing information associated with the POCs, the event or topic categories discussed by the POCs, for example.

Examples of this disclosure can be used to generate training data for predictive models used to predict future sentiment and timing information related to sample users. Thereby, systems herein provide improvements in the fields of online network management by providing informed data on potential problematic account holders.

Examples of this disclosure can consider information divergence according to the severity of events discussed in a network of conversations, and specifically can automatically adjust allowable sentiment divergence threshold values based on the criticalness of the discussion. For example, event categories related to natural disasters, geo-political emergencies, missing-person events, or any other time-sensitive and critical emergency situations can be detected from a base POC, and related POCs can be maintained to have sentiment similar to the base POC to ensure accurate and efficient dissemination of the time-crucial emergency information. Thereby, systems herein provide for improved communication in online social networks.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. For example, the various apparatus and devices of the various embodiments described herein may be constructed using various off-the-shelf components, such as PCBs, and other mechanical and electrical components which perform the same function as the particular components described herein. As such, the language used herein is intended to be given the broadest possible scope and meaning; and the embodiments are meant to be exemplary, not exhaustive. Also, it is to be understood that the phraseology and terminology employed herein are for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entireties to the same extent as if the contents of each individual patent or publication were specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that a thing possesses or occurs in an amount, duration, degree or other measure or parameter value that is 90% to 99% of which the thing is being compared to.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

Where used herein, the term “integrated circuit” is also intended to refer to a device known as a semiconductor chip, a microchip, a computer chip, and a microprocessor chip.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The term “exemplary” is intended to mean “an example of.”

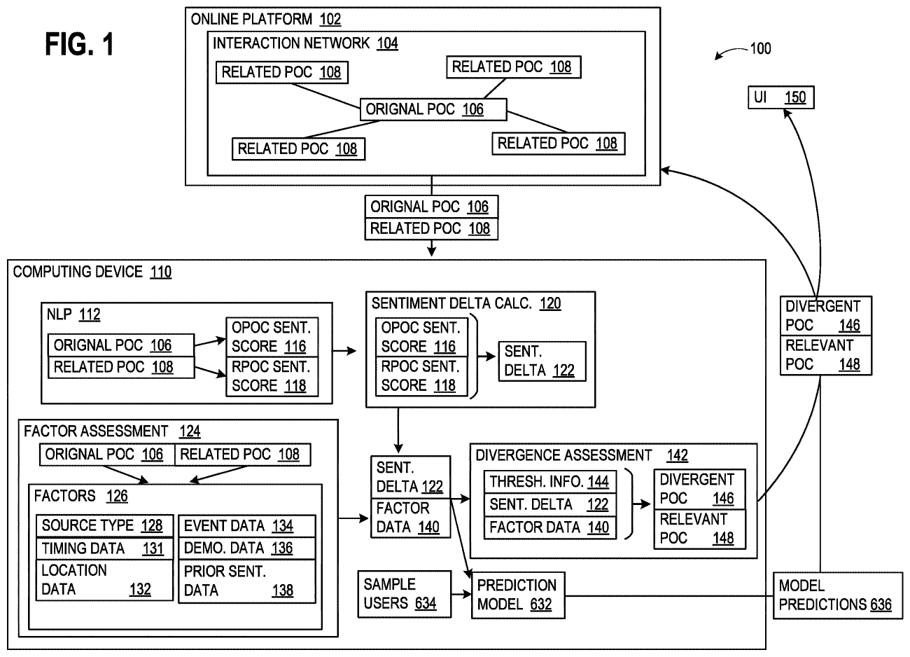

Returning to the description of several embodiments of the disclosure, reference is now made to the figures. FIG. 1 illustrates an exemplary architecture 100 that advantageously provides for measuring and identifying information divergence in online interactions. Architecture 100 includes an online platform 102, which can comprise any of various internet communication platforms, such as social media platforms like Facebook®, Instagram®, X® (formerly, Twitter®), Reddit®, LinkedIn®, or any similar platform.

As those with skill in the art will understand, online platform 102 can be described as hosting a plurality of interaction networks 104, each interaction network 104 comprising an original piece of online content (POC) 106 and various related POCs 108 that are related to the original POC 106. For example, the original POC 106 can be an original post, message, or tweet, for example, and the related POC 108 can be a reply, repost, retweet, mention, tag, or any other action that is linked to the original POC 106. Original POC 106 and related POCs 108 can comprise any of various formats, such as text, images, videos, URL links, or a combination of these. Herein, original POC 106 and various related POCs 108 will be described with text format examples, but those with skill in the art will understand that other formats are included in the scope of this disclosure, such as image, audio, or video formats, for example.

Architecture 100 further includes a computing device 110 that is used in measuring and identifying information divergence in interactions on online platform 102, such as within interaction network 104. As shown, computing device 110 retrieves original POC 106 and the various related POCs 108. While retrieval and processing of just one related POC 108 is shown for illustrative purposes, those with skill in the art will understand that each of the related POCs 108 can be retrieved by computing device 110, and such retrieval can be done in real-time as interaction network 104 grows with more and more related POCs 108.

Computing device 110 may then process original POC 106 and related POC 108 using a natural language processor (NLP) 112 to obtain certain pieces of information related to each POC. For example, in some embodiments, the NLP 112 performs sentiment analysis to obtain information related to the mood, mentality, or relevance of the text. NLP 112 can thereby generate an original POC sentiment score 116 for original POC 106 and a related POC sentiment score 118 for related POC 108.

Computing device 110 may perform sentiment delta calculation 120 by ascertaining the difference between original POC sentiment score 116 and related POC sentiment score 118 to generate a sentiment delta 122.

Computing device 110 can further perform factor assessment 124 to determine various factors 126 associated with the original POC 106 and the related POC 108. For example, factors 126 can include determining the source of the POC, such as if the user is an individual, company, government entity, non-profit organization, bot, news outlet, or any other source classification. Factors 126 can include timing data 131 related to the time at which the POC was made or posted on online platform 102. Factors 126 can include location data 132 that can be gathered using geotagging of the POC, user-provided location information, or from location data taken from a user device on which the POC was posted, for example. Factors 126 can include event data 134, which relates to a certain event that a POC might be related to, such as a live-entertainment or sporting event or an emergency event, such as a meteorological, missing-person, geopolitical, crime, epidemic, or other emergency event. Event data 134 can be gathered via geotagging, keyword detection, or by other similar detection techniques. Factors 126 can include demographic data 136, which can be user-supplied data related to the account holder related to the POC, such as citizenship, residence information, race, age, gender, income, or any other demographic information that may be ascertainable from online platform 102. Factors 126 can further include prior sentiment data 138, which can include statistical information that relates historical sentiment delta 122 scores related to the account holder of the POCs. That is, prior sentiment data 138 can relate to whether or not an account holder has a reputation for diverging from an original POC 106 based on past sentiment delta 122 information. As those with skill in the art will understand, these are just some of the various similar factors that can be determined during factor assessment 124.

Using factor data 140 from factor assessment 124 and sentiment delta 122 from sentiment delta calculation 120, computing device 110 can perform divergence assessment 142 to determine whether the content of related POC 108 is divergent or relevant to the content of original POC 106. During divergence assessment 142, computing device 110 can use threshold information 144 to determine whether sentiment delta 122 classifies the related POC 108 as a divergent POC 146 or a relevant POC 148. In response to the sentiment delta 122 exceeding the threshold information 144, the related POC 108 is classified as a divergent POC 146, and in response to the sentiment delta 122 not exceeding the threshold information 144, the related POC 108 can be classified as a relevant POC 148.

According to some embodiments, threshold information 144 can be defined by a user or administrator. In some embodiments, threshold information 144 can be based on factor data 140. For example, identified factors 126 can be used to generate threshold information 144. As a non-limiting and purely illustrative example, timing data 131 can be used to affect threshold information 144. For example, computing device 110 can minimize the allowable sentiment delta 122 via threshold information 144 during times corresponding to a meteorological emergency so that related POCs 108 with relatively small sentiment delta 122 values are identified as relevant POCs 148. After the meteorological emergency has passed, the threshold information 144 can be enlarged to allow a wider range of related POCs 108 to be marked as relevant POC 148. Those with skill in the art will understand that this is just one illustrative example of how factor data 140 can be used by computing device 110 during divergence assessment 142 to determine appropriate threshold information 144. According to various embodiments, factor data 140 is optional in performing divergence assessment 142, and computing device 110 instead relies just on sentiment delta 122 and utilizes predefined threshold information 144.

Computing device 110 can then provide divergent POC 146 and relevant POC 148 information as outputs, such as to online platform 102 and/or to a user interface 150, for example, to be used in auditing, surveying, or managing interaction network 104, or for various other purposes related to the health of the online platform 102.

In some examples, factor data 140 and sentiment delta 122 can be used as training data for training a prediction model 632, where the prediction model is used for generating model predictions 636 relating to predicted sentiment values for sample users 634 where sentiment values are unestablished or otherwise unknown. Predictions 636 can be delivered to online platform 102 and/or displayed via user interface 150, as will be discussed in greater detail below.

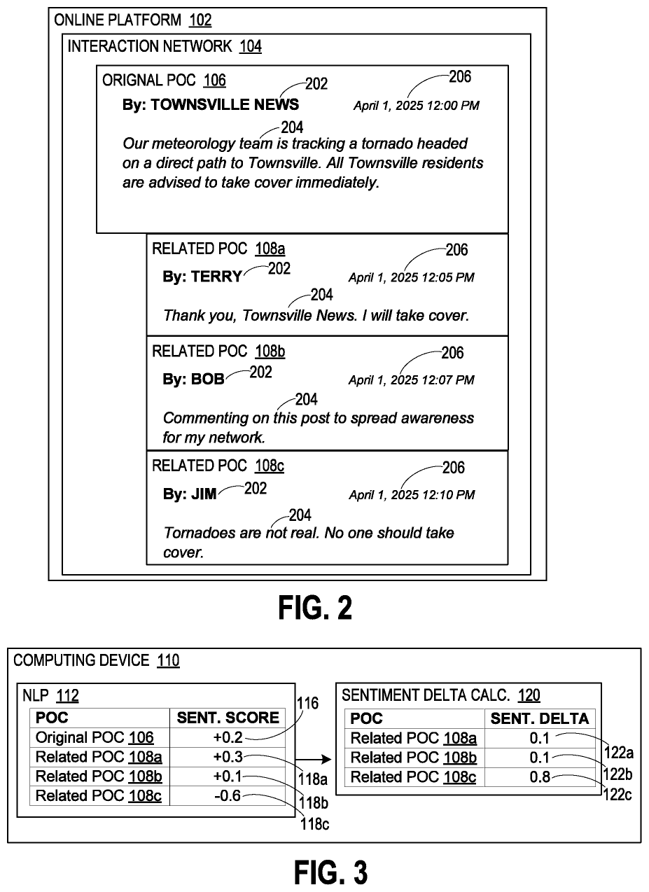

FIG. 2 provides an illustrative example of an interaction network 104 on online platform 102. In this illustrative non-limiting example, original POC 106 belongs to an account holder 202 “Townsville News,” which is a news media organization for a community Townsville. Here, the content 204 of original POC 106 is that a tornado is coming to the area and a warning to take cover, and the posted-at time 206. There are three related POCs 108a-108c which are each a reply message to the original POC 106, each made by a different account holder 202 and including different content 204 and at different times 206.

FIG. 3 illustrates how computing device 110 uses NLP 112 in generating original POC sentiment score 116 for original POC 106 and related POC sentiment scores 118a-118c for each related POC 108a-108c. As shown, related POCs 108a-108b have related POC sentiment score 118a-118b close to original POC sentiment score 116 since the content 204 of each of related POCs 108a-108b is generally related to the content 204 of original POC 106, however, related POC sentiment score 118c is displaced from original POC sentiment score 116 since the content 204 of related POC 108c has a different sentiment than original POC 106. As shown, original POC 106 is related to safety for an incoming tornado, and related POC 108c claims that tornadoes are not real. Computing device 110 then performs sentiment delta calculation 120 to determine a sentiment delta 122a-122c associated with each related POC 108a-108c. As shown, sentiment delta 122a-122c is the difference between the original POC sentiment score 116 and the corresponding related POC sentiment score 118a-118c.

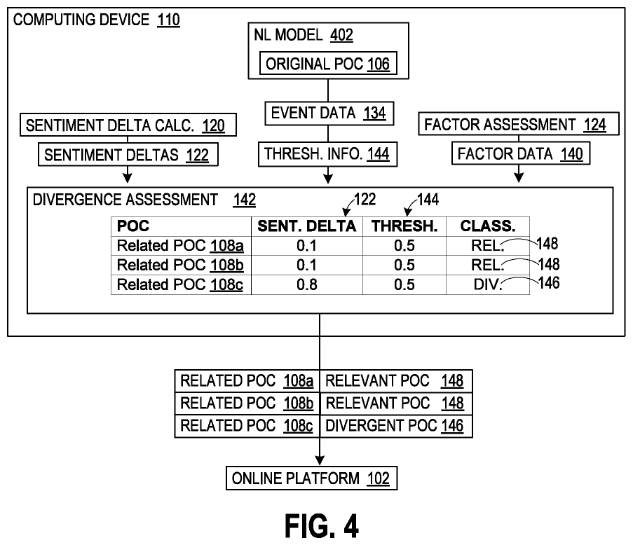

FIG. 4 illustrates a computing device performing divergence assessment 142 on related POCs 108a-108c. As previously discussed, divergence assessment 142 is performed using sentiment deltas 122a-122c and factor data 140 resulting from factor assessment 124. Factor data 140 can include any of the various factors 126 related to related POCs 108a-108c and their corresponding account holders 202. That is, each individual related POC 108a-108c has its own packet of factor data 140 relating to that individual related POC, and divergence assessment 142 is performed individually on each related POC using its related packet of factor data 140.

Specifically, as previously discussed, computing device 110 uses each related POC's 108a-108c corresponding factor data 140 packet to determine threshold information 144 corresponding to the related POC 108a-108c. In some examples, threshold information 144 is determined based on event data 134 associated with the original POC 106. Specifically, a natural language (NL) model 402 can be utilized by computing device 110 to determine event data 134 associated with the original POC 106. After determining the event data 134, computing device 110 can be programmed to determine threshold information 144 that corresponds to the event data 134. For example, if the event data 134 shows that original POC 106 is associated with a natural disaster or other emergency situation, computing device 110 can be programmed to assign a relatively small threshold information 144 to any related POCs 108 to ensure sentiments remain consistent with the sentiment of the emergency situation discussed in original POC 106. For example, if the event data 134 shows that original POC 106 is associated with a less-critical topic, computing device 110 can be programmed to assign a relatively large threshold information 144 to any related POCs 108. NL model 402 can include any of various NL models that are designed and/or trained to analyze text in its given context and thereby identify event data 134. In some examples, NLP 112 includes NL model 402, and in some examples, NL model 402 is different from NLP 112.

In some examples, each related POC 108a-108c has its own individual threshold information 144 that is based on the factor data 140 corresponding to that POC. Those with skill in the art will understand that computing device 110 can employ any of various algorithms, models, and/or machine learning techniques in determining the threshold information 144 based on the various factors 126 included in factor data 140. One specific piece of data that can be included in factor data 140 is timing data 131, as previously discussed. Timing data 131 includes the time 206 associated with each POC, and specifically a time delta between the time 206 of original POC 106 and the time 206 of the related POC 108. For example, as previously mentioned, when time deltas are small, the divergence assessment 142 may minimize threshold information 144 to ensure related POCs 108 initially remain relevant to the original POC 106 such that related POCs 108 do not diverge from the intended purpose of original POC 106 too fast or in a drastic manner. Those with skill in the art will understand that this is just one illustrative example of how timing data 131 can be used to generate time deltas that are used in divergence assessment 142 to generate appropriate threshold information 144.

Still in some examples, threshold information 144 can be defined by a user of the system discussed herein. For example, threshold information 144 can be set via a user interface, as will be discussed in greater detail below.

Divergence assessment 142 includes comparing each sentiment delta 122 to the corresponding threshold information 144 to determine a divergence classification for each related POC 108a-108c. In response to determining that the sentiment delta 122 is less than the threshold information 144, computing device 110 classifies the related POC 108 as a relevant POC 148, as shown with related POCs 108a-108b. In response to determining that the sentiment delta 122 is greater than the threshold information 144, computing device 110 classifies the related POC 108 as a divergent POC 146, as shown with related POC 108c. It can also be said that each related POC 108 is tagged as either being a divergent POC 146 or a relevant POC 148. These tags can then be used in various ways that will be apparent to those skilled in the art, including being delivered to online platform 102, as shown.

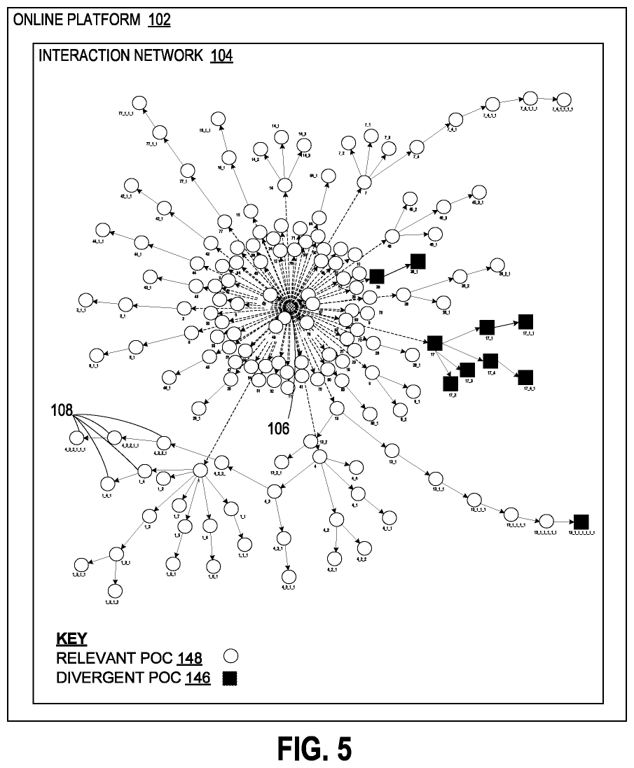

FIG. 5 illustrates a representation of an interaction network 104 of online platform 102 utilizing the information resulting from divergence assessment 142. Interaction network 104 illustrates a network of linked related POCs 108 all stemming from an original POC 106. Interaction network 104 can be used to visualize the occurrence of divergent POCs 146 and clustering or spreading patterns related thereto. Additionally, online platform 102 can be provided with data from computing device 110 continuously and in real-time, such that the interaction network 104 can be updated in real-time as related POCs 108 are being generated. Thus, users or managers associated with online platform 102 can be informed as to the accuracy, reliability, efficiency, and/or intended functionality of interaction network 104.

Those with skill in the art will understand that the identification of divergent POCs 146 and relevant POC 148 can be utilized in different scenarios. Online platform 102 may desire to employ certain interaction networks 104 dedicated to certain subjects, and may wish to identify divergent POCs 146 to maintain order within the interaction network 104. For example, online platform 102 may have an interaction network 104 dedicated to discussing baseball, and may desire only to allow baseball-related discussions within that particular interaction network 104. Accordingly, a divergent POC 146 related to horseback riding can be identified with the architecture 100 and communicated to online platform 102, such that the horseback riding POC can be moved to an appropriate section of online platform 102 and maintain the functionality and efficiency of the baseball network. Additionally, in times of crisis, such as meteorological disasters, missing person events, crimes, and other crisis events, architecture 100 can be utilized to identify divergent POCs 146 containing unhelpful information for the crisis, such as unfounded rumors, deceptive information, unrelated information, and the like. Thereby, the identified divergent POCs 146 can be dealt with appropriately by the online platform 102, such as by flagging the POC as divergent from the original POC 106, or by using similar remedies. Accordingly, architecture 100 can be used to help in the dispersion of helpful and beneficial information during times of crisis.

Additionally, sentiment delta 122 information, along with divergence information for particular account holders, can be delivered to online platform 102. Those with skill in the art will understand that this can be used by online platform 102 in any of various ways. For example, online platform 102 can identify certain account holders as consistently generating related POCs 108 that diverge from the original POC 106. Thereby, online platform 102 can provide feedback or education to the account holder about the terms of the online platform 102. Additionally, sentiment delta 122 related to certain factors 126 can be provided to online platform 102, so that patterns across the various factors 126 can be ascertained.

In some examples, computing device 110 generates interaction network 104, where each relevant POC 148 and divergent POC 146 are color-coded or otherwise identifiable, and are displayed via user interface 150. In some examples, each node of interaction network 104 is further color-coded or otherwise identifiable based on the identified source type 128, and each node can be selectable to display information relating to the POC, such as account holder 202 or any of factors 126.

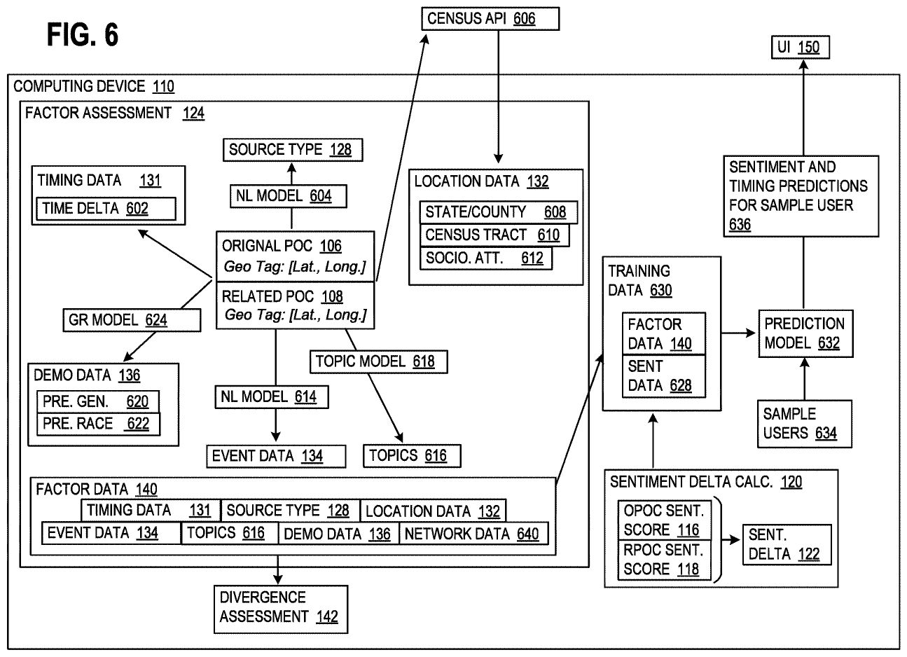

FIG. 6 is a block diagram illustrating operations performed in factor assessment 124. Further shown are operations that can be performed by computing device 110 using data from factor assessment 124, such as for use in divergence assessment 142, or for use as training data for a predictive model, for example.

In this illustrative example, factor assessment 124 is depicted using original POC 106 and related POC 108; however, according to various examples, factor assessment 124 is performed on multiple related POCs 108 for an original POC 106 and/or on multiple original POCs 106. Each of the operations depicted in factor assessment 124 can be performed on both related POCs 108 and original POCs 106.

Timing data 131 can be determined from the original POC 106 and related POC 108. For example, each POC can be encoded or otherwise labeled with a time associated with the POC, such as time 206 previously discussed, and computing device 110 can identify this timing information. Computing device 110 can further generate a time delta 602 as part of timing data 131, which is a difference in the time 206 of the original POC 106 and the time 206 of the related POC 108. This time delta 602 can be valuable in training analysis and divergence assessment. For example, in situations where timing is critical, such as emergency or disaster situations, related POCs 108 made close in time to original POC 106 can be relied upon by others during crucial periods related to the emergency and thus are important to considerations in divergence assessment.

As part of factor assessment 124, computing device 110 can determine the source type 128 of each POC, which can also be referred to herein as a category classification. Example source types 128 can include human users, public agencies, bots, companies, non-profit organizations, government entities, news organizations, academic institutions, or any other account holder 202 for an account belonging to the online platform 102. In some examples, natural language model 604 is used for determining the source type 128. For example, a named entity recognition (NER) model, such as spaCy's NER, is used to classify each account holder 202 as an appropriate source type 128. NER models can effectively extract named entities from text, and thus allow for distinctions between different account types.

In some examples, each POC is geo-tagged with latitude-longitude coordinates associated with the generation of the POC. These geo-tagged location coordinates can be used by computing device 110 in generating location data 132. In some examples, computing device 110 provides the latitude-longitude coordinates for each POC to a U.S. Census Bureau application program interface (census API 606) for performing reverse geo-coding. Specifically, from the latitude-longitude coordinates, computing device 110 is able to retrieve associated location data 132 for each POC, such as the state and country 608 and/or the census tract 610 to which the latitude-longitude coordinates belong. A census tract is a small, statistical subdivision of a county defined by the U.S. Census Bureau for the purpose of collecting and reporting detailed demographic, social, and economic data. Thus, from census API 606, which can also be referred to herein as a location API, socioeconomic attributes 612 associated with the latitude-longitude coordinates for the POC can also be determined, such as average income, average level of education, or housing types, for example.

Factor assessment 124 can further comprise determining event data 134 associated with the POC. Event data 134 can relate to a category of events discussed in the POC. Event data 134 can include, for example, natural disaster categories, such as tornado, flood, heat wave, wildfire, strong wind, earthquake, or other natural disasters. Event data 134 can include other categories, such as emergency categories, such as Amber alerts, missing person alerts, military warnings, wellness and disease updates, and the like. These are just some examples of critical event data 134 categories, and those with skill in the art will understand that various others fall within the scope of this disclosure. Event data 134 can also include less critical categories that people create content for in their everyday life. The event data 134 can be determined by a natural language (NL) model 614 trained to identify events from POC. For example, NL model 614 can include a Bidirectional Encoder Representations from Transformers (BERT) model designed to understand natural language in context. NL model 614 can include any of various NL models that are designed and/or trained to analyze text in its given context and thereby identify event data 134. In some examples, NL model 614 is the NL model 402 previously discussed.

Factor assessment 124 can further include identifying relevant topics 616 within the event category identified in event data 134. For example, if event data 134 is related to a tornado, associated relevant topics 616 could be counties under a tornado warning, road closures, the tornado's path, instructions to take cover, or any other relevant topic related to the tornado. Computing device 110 can determine relevant topics 616 using a topic model 618 designed to perform natural language processing to discover topics from groups of text. In some examples, topic model 618 groups POCs into distinct topics based on content similarity. In some examples, topic model 618 can comprise a Latent Dirichlet Allocation (LDA) model, but topic model 618 can comprise any of various topic models according to various examples of this disclosure.

Computing device 110 can further predict certain demographic data 136 from each POC, such as the predicted gender 620 and predicted race 622 of the account holder 202 associated with the POC. Computing device 110 can utilize a gender-race model 624 in predicting this demographic data 136. Gender-race model 624 can be any of various machine learning models that infer or predict demographic attributes—such as gender and race—from data about individuals, such as from the name of the account holder 202, for example.

Factor assessment 124 can further include determining network data 640 associated with the POCs and/or the associated interaction network 104. For example, network data 640 can include closeness centrality values, eigenvector centrality values, clustering coefficient, average degree values, average neighbor degree values, network diameter, network density, and any other values associated with network metrics related to the POC within a given interaction network. As will become clearer based on the description of prediction model 632 below, based on network data 640, prediction model 632 can be trained to recognize sentiment and timing patterns based on interaction metrics within a given network captured in network data 640.

Computing device 110 can tag or otherwise associate each POC with the associated information identified during factor assessment 124 as factor data 140, such as timing data 131, source type 128, location data 132, event data 134, relevant topics 616, demographic data 136, and network data 640, for example. Additionally, computing device 110 can tag or otherwise associate each POC with associated sentiment data, such as original POC sentiment score 116, related POC sentiment score 118, and/or sentiment delta 122 (collectively, sentiment data 628). Computing device 110 can form training data 630 comprising factor data 140 for each analyzed POC in factor assessment 124 and its associated sentiment data 628.

Computing device 110 can deliver training data 630 to a prediction model 632 to train the prediction model to generate various predictions associated with sample users 634. For example, sample users 634 could be account holders new to online platform 102 that do not yet have sufficient data for understanding sentiment patterns or timing patterns associated with the user. Prediction model 632 can be trained with training data 630 to generate sentiment and/or timing predictions 636 for sample users 634. For example, sample users 634 can include specified factors related to the account holder, such as any of the factors discussed in factor assessment 124, and prediction model 632 can predict sentiment data and/or timing associated with the user as part of predictions 636, such as average predictive sentiment deltas and/or timing deltas for future POCs from the users represented in sample users 634. Predictions 636 can be presented via user interface 150, such as by any of the example interfaces discussed in greater detail below.

Prediction model 632 can comprise any of various prediction and/or machine learning models that can be trained by training data 630 to generate sentiment and/or timing predictions for sample users 634 where only certain factors 126 are known. In some examples, prediction model 632 can comprise a linear regression model. Various other models, such as ensemble, regression, and/or machine learning models could be used for prediction model 632. In various examples, a support vector regression (SVR) model, a random forest model, or an XGBoost model could be used for prediction model 632, for example. Any of various predictive models fall within the scope of this disclosure.

Factor data 140 can also be used by computing device 110 in performing divergence assessment 142, as has been previously discussed. For example, computing device 110 can be programmed to consider certain factor information in determining whether an original POC 106 is a divergent POC 146. For example, computing device 110 can be programmed to consider POCs having a certain time delta 602 within a defined range as being potential divergent POCs 146. For example, computing device 110 can be programmed to consider POCs having a certain source type 128 as being potential divergent POCs 146, (for example, if the source type 128 is a bot). For example, computing device 110 can be programmed to consider POCs having certain location data 132 as being potential divergent POCs 146. For example, if the county in state/county 608 for a related POC 108 does not match the county in state/county 608 in original POC 106 when the original POC 106 is related to a weather emergency in the county. For example, computing device 110 can be programmed to consider POCs having certain event data 134 and/or relevant topics 616 as being potential divergent POCs. For example, if the event data 134 and/or relevant topics 616 of the related POC 108 do not match those of the original POC 106. Accordingly, various data within factor data 140 can be used by computing device 110 in performing divergence assessment 142. Factor data 140 can be used in divergence assessment 142 in conjunction with sentiment delta 122 data or on its own.

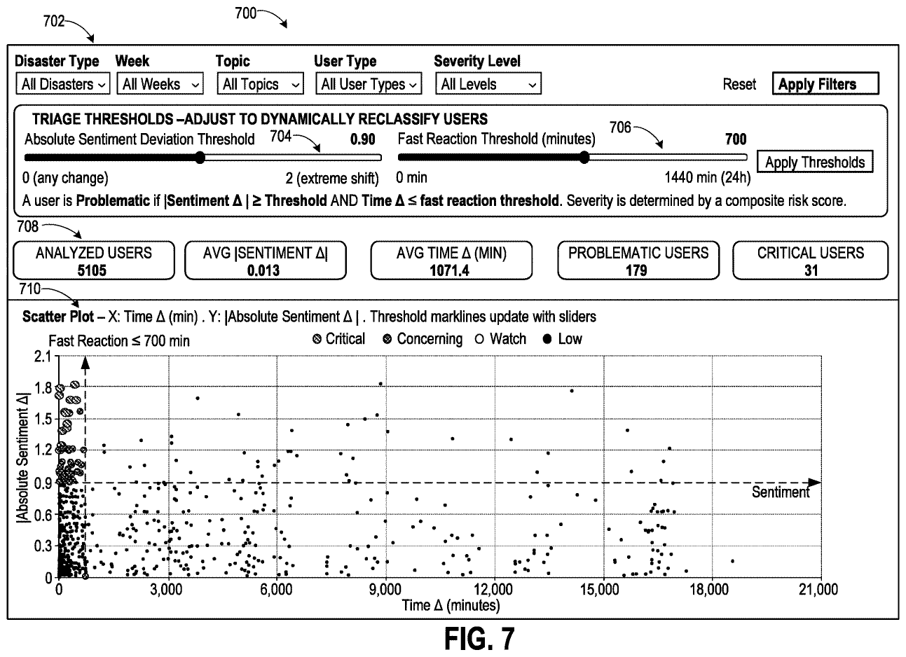

FIGS. 7-10 illustrate example user interface displays for interpreting and analyzing the analysis performed throughout this application, such as for viewing divergent POCs 146, relevant POC 148, results from factor assessment 124, results from divergence assessment 142, and/or results from prediction model 632, for example. FIG. 7 illustrates a user interface display 700 for reviewing sentiment analysis data, such as in viewing results from factor assessment 124, results from divergence assessment 142, and/or results from prediction model 632, for example. User interface display 700 includes a factor filter section 702 where the data presented can be filtered according to any of the factors, such as factors 126, discussed herein. Display 700 includes a sentiment threshold definition section 704 where a user can define threshold information 144 that qualifies a user or POC as divergent. Display 700 includes a time delta definition section 706 where a user can identify a time delta 602 or average user response time as divergent. Display 700 can include a result summary section 708 that can summarize the number of entries analyzed, the average sentiment delta, the average time delta, and the number of divergent users according to the settings in sentiment threshold definition section 704 and time delta definition section 706. There can be different classifications of divergence, such as “critical”, “concerning”, and “watch” for example. Display 700 can include a scatter plot 710 illustrating the analyzed POC or user with axes defining the sentimental delta and the time delta, as shown. Each node can represent an account holder 202 or a POC. Each node can be selectable to view additional details related to the node, such as the account holder 202, the POC, or the factors 126, for example. Each node can be color coded or otherwise identifiable according to its level of divergence. As shown, divergent nodes can be defined according to user entries specified in sentiment threshold definition section 704 and time delta definition section 706.

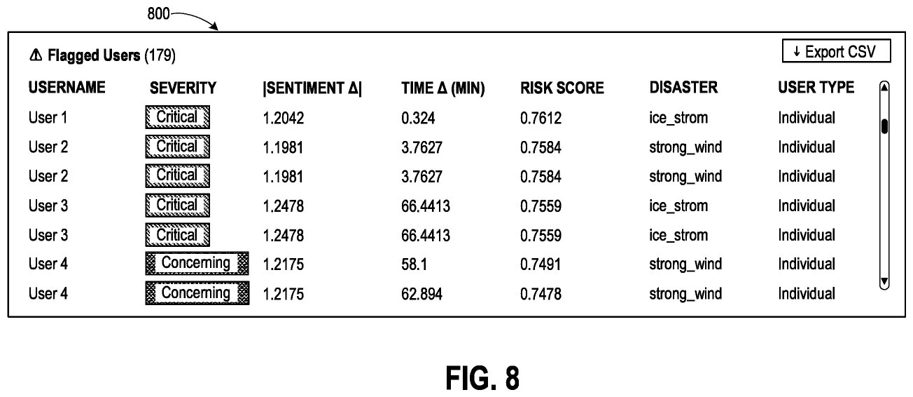

FIG. 8 is another user interface that can display account holders 202 associated with nodes of interest from FIG. 7, such as divergent nodes. As shown, various information previously discussed can be displayed related to each associated POC or account holder 202.

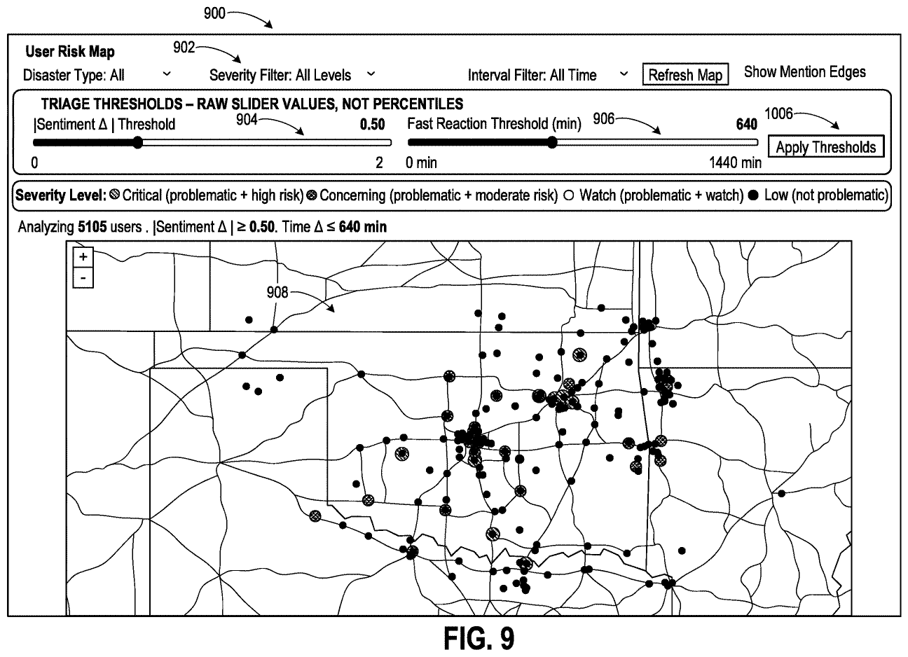

FIG. 9 shows a risk map display 900. Like display 700, risk map display 900 can include a filter section 902 substantially similar to factor filter section 702, a sentiment threshold definition section 904 substantially similar to sentiment threshold definition section 704, and a time delta definition section 906 similar to time delta definition section 706. Risk map display 900 displays a geographic risk map 908 where each account holder 202 or POC can be displayed according to the associated location data 132. Additionally, each node can be color coded or otherwise identifiable according to its level of divergence (low, watch, concerning, critical, etc.). Accordingly, risk map display 900 can be utilized by a user to easily identify geographic areas associated with information divergence. Each node can be selectable to display information related to the node, such as account holder 202 information, associated factor data 140 information, or the contents of a POC, for example.

Risk map display 900 shows a geographical network map but, according to various examples, various other mapped networks can be included as a display, such as interaction network 104 previously discussed.

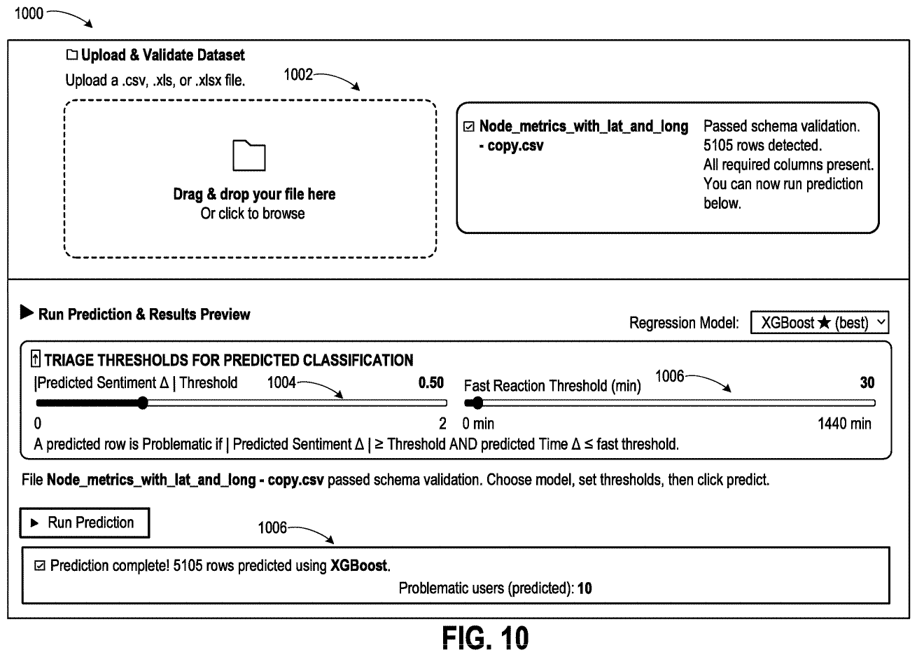

FIG. 10 shows a prediction model display 1000 for generating predictions 636 based on sample users 634. Sample users 634 can be provided at a data input section 1002 as a dataset file. Sentiment and timing delta definitions can be provided in sections 1004 and 1006, respectively, in the same manner previously discussed in FIGS. 7 and 9, for example. The prediction model 632, trained by training data 630, can generate predictions 636, and such predictions can be displayed, such as in displays 700, 800, 900 previously discussed, for example.

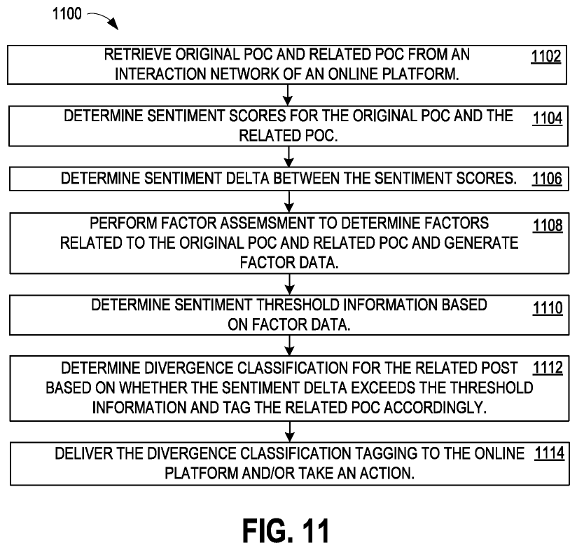

FIG. 11 is a flowchart illustrating a method 1100 for measuring and identifying information divergence in online interactions. Method 1100 can begin at block 1102 by computing device 110 retrieving original POC 106 and related POC 108 of interaction network 104 from online platform 102. Those with skill in the art will understand that method 1100 can be performed using any number of POCs. Method 1100 can continue to block 1104 where computing device 110 uses NLP 112 to determine original POC sentiment score 116 and related POC sentiment score 118. Method 1100 can continue to block 1106 where computing device 110 performs sentiment delta calculation 120 to calculate sentiment delta 122 between original POC sentiment score 116 and related POC sentiment score 118.

Method 1100 can continue to block 1108 where computing device 110 performs factor assessment 124 to determine factors 126 associated with each of the original POC 106 and related POC 108. As part of factor assessment 124, computing device 110 can generate factor data 140 related to each of the original POC 106 and related POC 108, which incorporates information related to factors 126.

Method 1100 can continue to block 1110, where computing device 110 performs divergence assessment 142. Specifically, computing device 110 determines appropriate threshold information 144 based on the factor data 140 for the related POC 108 and/or the original POC 106. In some examples, threshold information 144 is determined based on the contents of original POC 106. In some examples, threshold information 144 is generated based on event data 134 identified from original POC 106 by NL model 402. Herein, threshold information 144 can be referred to as a sentiment threshold value.

Method 1100 can continue to block 1112 where architecture 100 continues in divergence assessment 142. Specifically, computing device 110 determines a divergence classification for the related POC 108 based on at least whether the sentiment delta 122 exceeds the threshold information 144. As previously discussed, when the sentiment delta 122 exceeds the threshold information 144, computing device 110 identifies the related POC 108 as a divergent POC 146 and tags the related POC 108 as such. When the sentiment delta 122 does not exceed the threshold information 144, computing device 110 identifies the related POC 108 as a relevant POC 148 and tags the related POC 108 as such.

In some examples, divergence assessment 142 is further based on factors identified as part of factor assessment 124. In some examples, divergence assessment 142 is further based on location data 132 associated with the original POC 106 and the related POC 108. In some examples, divergence assessment 142 is further based on timing data 131, such as time delta 602, associated with the original POC 106 and the related POC 108. In some examples, divergence assessment 142 is further based on event data 134 and/or relevant topics 616 associated with the original POC 106 and the related POC 108.

Method 1100 can continue to block 1114, where computing device 110 delivers the tagged information to online platform 102 for use by online platform 102 in managing or otherwise surveying interaction network 104. Block 1114 can further include presenting divergence information, including the tagged divergent POCs 146 via user interface 150, such as by any of displays 700-900 or interaction network 104, for example. In some examples, block 1114 can further include taking an action based on detecting divergent POCs 146, such as automatically updating the POC on the online platform 102 to include a warning label relating to the related POC 108 as including information divergent from the original POC 106; removing the related POC 108 from the online platform 102; sending a notification to the account holder 202 associated with related POC 108 that the content of the POC contains divergent information; sending the account holder 202 educational information relating to terms of the online platform 102; or any other corrective or associated action associated with information divergence of the POC.

Method 1100 depicts blocks 1102-1114 being performed in a certain order, but those with skill in the art will recognize that blocks 1102-1114 can be performed in any of a number of orders without departing from the scope of this disclosure. Additionally, method 1100 can include more or less than the blocks 1102-1114 without departing from the scope of this disclosure.

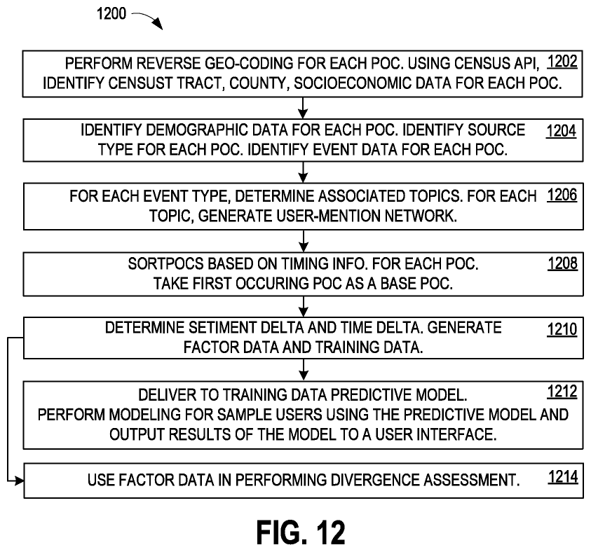

FIG. 12 is a flowchart illustrating a method 1200 for performing factor assessment 124, such as for use in divergence assessment 142 or for generating training data 630, for example. Method 1200 can begin at block 1202 by performing reverse geo-coding of geo-tagged POCs using census API 606 to generate location data 132 associated with each POC. Method 1200 can continue to block 1204 by generating demographic data 136, identifying source type 128, and identifying event data 134 for each POC. Method 1200 can continue to block 1206 by determining relevant topics 616 for each event category identified in event data 134.

Method 1200 can continue to block 1208 by, for each relevant topic 616, sorting the corresponding POCs according to timing data 131, and identifying the first occurring POC as an original POC 106. Method 1200 can continue to block 1210 by determining sentiment data 628, including sentiment delta 122, and timing data 131, including time delta 602, for each original POC 106 and its associated related POCs 108. Block 1210 can further include generating factor data 140, and further generating training data 630 including factor data 140 and sentiment data 628.

Method 1200 can continue to block 1212 by delivering training data 630 to prediction model 632 to train prediction model 632 in generating sentiment and/or timing predictions for sample users 634. Block 1212 can further include generating sentiment and/or timing predictions 636 for sample users 634 using trained prediction model 632. Block 1212 can further include displaying predictions 636 on user interface 150, such as by any of displays 700-900 or interaction network 104, for example. Method 1200 can also continue from block 1210 to block 1214 by using factor data 140 as part of divergence assessment 142.

Method 1200 depicts blocks 1202-1214 being performed in a certain order, but those with skill in the art will recognize that blocks 1202-1214 can be performed in any of a number of orders without departing from the scope of this disclosure. Additionally, method 1200 can include more or less than the blocks 1202-1214 without departing from the scope of this disclosure. According to various examples of this disclosure, operations of method 1100 and method 1200 can be combined and/or interchanged.

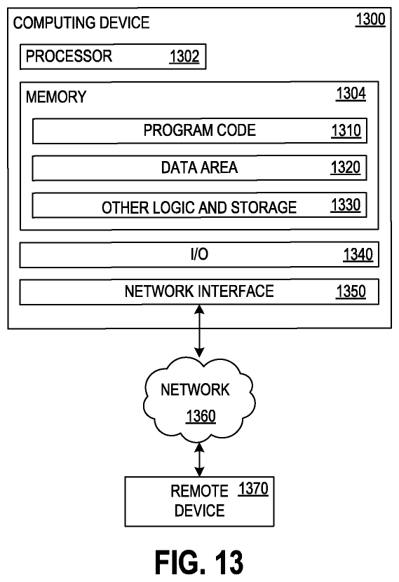

FIG. 13 illustrates a block diagram of computing device 1300 that may be used as any component described herein that may require computational or storage capacity. Computing device 1300 has at least a processor 1302 and a memory 1304 that holds program code 1310, data area 1320, and other logic and storage 1330. Memory 1304 is any device allowing information, such as computer-executable instructions and/or other data, to be stored and retrieved. For example, memory 1304 may include one or more random access memory (RAM) modules, flash memory modules, hard disks, solid-state disks, persistent memory devices, and/or optical disks. Program code 1310 comprises computer-executable instructions and computer-executable components including instructions used to perform operations described herein. Data area 1320 holds data used to perform operations described herein. Memory 1304 also includes other logic and storage 1330 that performs or facilitates other functions disclosed herein or otherwise required of computing device 1300. An input/output (I/O) component 1340 facilitates receiving input from users and other devices and generating displays for users and outputs for other devices. A network interface 1350 permits communication over external network 1360 with a remote device 1370, which may represent another implementation of computing device 1300. For example, a remote device 1370 may represent another of the above-noted devices within architecture 100.

By way of example and not limitation, computer-readable media comprise computer storage media and communication media. Computer storage media include volatile and nonvolatile, removable and non-removable memory implemented in any method or technology for storage of information such as computer-readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer-readable instructions, data structures, program modules, or the like in a modulated data signal such as a carrier wave or other transport mechanism and include any information delivery media. The term “computer-readable media” may be one or more integrated circuits.

### Additional Examples

An example method of this disclosure comprises retrieving an original piece of online content (POC) from an online platform; retrieving a related POC from the online platform, wherein the related POC is associated with or related to the original POC; determining, using a natural language (NL) model, a first sentiment score for the original POC and a second sentiment score for the related POC; determining a sentiment delta between the first sentiment score and the second sentiment score; determining a sentiment threshold value; performing a divergence assessment comprising at least comparing the sentiment delta to the sentiment threshold value; in response to at least determining that the sentiment delta exceeds the sentiment threshold value as part of the divergence assessment, tagging the related POC as a divergent POC; and displaying, on a user interface, a notification associated with the related POC tagged as a divergent POC.

Alternatively, or in addition to the other examples described herein, examples include any combination of the following:
generating the sentiment threshold value based on contents of the original POC.
determining, using a natural language model, an event associated with the original POC; and generating the sentiment threshold value based on the determined event.
determining a first census location associated with the original POC by referencing a census location API using a first geo-tag location associated with the original POC; determining a second census location associated with the original POC by referencing the census location API using a second geo-tag location associated with the related POC; and performing the divergence assessment further based on a comparison of the first census location and the second census location.
determining a time delta between a first time associated with the original POC and a second time associated with the related POC; and performing the divergence assessment further based on the time delta.
determining a time delta between a first time associated with the original POC and a second time associated with the related POC; determining factor data associated with each of the original POC and the related POC, the factor data include at least location information, event data, and demographic information associated with the original POC and the related POC; and generating a training dataset including the factor data and the sentiment delta.
delivering the training dataset to a prediction model, wherein the prediction model is configured to be trained using the training dataset to generate predictive sentiment data for sample users; and displaying the predictive sentiment data on the user interface.

An example system of this disclosure includes a processor; and a computer-readable medium storing instructions that are operative upon execution by the processor to perform the method described above.

One or more example computer storage devices of this disclosure has computer-readable instructions stored thereon, which, upon execution by a computer, cause the computer to perform the method described above.

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for performing language processing from user interaction data for identifying information divergence, the method comprising:
retrieving, by a processor, an original piece of online content (POC) from an online platform;
retrieving, by the processor, a related POC from the online platform, wherein the related POC is associated with or related to the original POC;
determining, by the processor using a natural language (NL) model, a first sentiment score for the original POC and a second sentiment score for the related POC;
determining, by the processor, a sentiment delta between the first sentiment score and the second sentiment score;
determining, by the processor, a sentiment threshold value;
performing, by the processor, a divergence assessment comprising at least comparing the sentiment delta to the sentiment threshold value;
in response to at least determining that the sentiment delta exceeds the sentiment threshold value as part of the divergence assessment, tagging, by the processor, the related POC as a divergent POC; and
displaying, by the processor on a user interface, a notification associated with the related POC tagged as a divergent POC.

2. The method of claim 1, further comprising generating, by the processor, the sentiment threshold value based on contents of the original POC.

3. The method of claim 1, further comprising:
determining, by the processor using a natural language model, an event associated with the original POC; and
generating the sentiment threshold value based on the determined event.

4. The method of claim 1, further comprising:
determining, by the processor, a first location associated with the original POC by referencing a location API using a first geo-tag location associated with the original POC;
determining, by the processor, a second location associated with the related POC by referencing the location API using a second geo-tag location associated with the related POC; and
performing, by the processor, the divergence assessment further based on a comparison of the first location and the second location.

5. The method of claim 1, further comprising:
determining, by the processor, a time delta between a first time associated with the original POC and a second time associated with the related POC; and
performing, by the processor, the divergence assessment further based on the time delta.

6. The method of claim 1, further comprising:
determining, by the processor, a time delta between a first time associated with the original POC and a second time associated with the related POC;
determining, by the processor, factor data associated with each of the original POC and the related POC, the factor data including at least location information, event data, and demographic information associated with the original POC and the related POC; and
generating, by the processor, a training dataset including the factor data and the sentiment delta.

7. The method of claim 6, further comprising:
delivering, by the processor, the training dataset to a prediction model, wherein the prediction model is configured to be trained using the training dataset to generate predictive sentiment data for sample users; and
displaying, by the processor, the predictive sentiment data on the user interface.

8. A system for performing language processing from user interaction data for identifying information divergence, the system comprising:
a processor; and
a computer-readable medium storing instructions executable by the processor to:
retrieve an original piece of online content (POC) from an online platform;
retrieve a related POC from the online platform, wherein the related POC is associated with or related to the original POC;
determine, using a natural language (NL) model, a first sentiment score for the original POC and a second sentiment score for the related POC;
determine a sentiment delta between the first sentiment score and the second sentiment score;
determine a sentiment threshold value;
perform a divergence assessment comprising at least comparing the sentiment delta to the sentiment threshold value;
in response to at least determining that the sentiment delta exceeds the sentiment threshold value as part of the divergence assessment, tag the related POC as a divergent POC; and
display, on a user interface, a notification associated with the related POC tagged as a divergent POC.

9. The system of claim 8, wherein the computer-readable medium further stores instructions executable by the processor to generate the sentiment threshold value based on contents of the original POC.

10. The system of claim 8, wherein the computer-readable medium further stores instructions executable by the processor to:
determine, using a natural language model, an event associated with the original POC; and
generate the sentiment threshold value based on the determined event.

11. The system of claim 8, wherein the computer-readable medium further stores instructions executable by the processor to:
determine a first location associated with the original POC by referencing a location API using a first geo-tag location associated with the original POC;
determine a second location associated with the related POC by referencing the location API using a second geo-tag location associated with the related POC; and
perform the divergence assessment further based on a comparison of the first location and the second location.

12. The system of claim 8, wherein the computer-readable medium further stores instructions executable by the processor to:
determine a time delta between a first time associated with the original POC and a second time associated with the related POC; and
perform the divergence assessment further based on the time delta.

13. The system of claim 8, wherein the computer-readable medium further stores instructions executable by the processor to:
determine a time delta between a first time associated with the original POC and a second time associated with the related POC;
determine factor data associated with each of the original POC and the related POC, the factor data including at least location information, event data, and demographic information associated with the original POC and the related POC; and
generate a training dataset including the factor data and the sentiment delta.

14. The system of claim 13, wherein the computer-readable medium further stores instructions executable by the processor to:
deliver the training dataset to a prediction model, wherein the prediction model is configured to be trained using the training dataset to generate predictive sentiment data for sample users; and
display the predictive sentiment data on the user interface.

15. A computer-readable medium for performing language processing from user interaction data for identifying information divergence, the computer-readable medium storing instructions executable by a processor to:
retrieve an original piece of online content (POC) from an online platform;
retrieve a related POC from the online platform, wherein the related POC is associated with or related to the original POC;
determine, using a natural language (NL) model, a first sentiment score for the original POC and a second sentiment score for the related POC;
determine a sentiment delta between the first sentiment score and the second sentiment score;
determine a sentiment threshold value;
perform a divergence assessment comprising at least comparing the sentiment delta to the sentiment threshold value;
in response to at least determining that the sentiment delta exceeds the sentiment threshold value as part of the divergence assessment, tag the related POC as a divergent POC; and
display, on a user interface, a notification associated with the related POC tagged as a divergent POC.

16. The computer-readable medium of claim 15, further storing instructions executable by the processor to generate the sentiment threshold value based on contents of the original POC.

17. The computer-readable medium of claim 15, further storing instructions executable by the processor to:
determine, using a natural language model, an event associated with the original POC; and
generate the sentiment threshold value based on the determined event.

18. The computer-readable medium of claim 15, further storing instructions executable by the processor to:
determine a first location associated with the original POC by referencing a location API using a first geo-tag location associated with the original POC;
determine a second location associated with the related POC by referencing the location API using a second geo-tag location associated with the related POC; and
perform the divergence assessment further based on a comparison of the first location and the second location.

19. The computer-readable medium of claim 15, further storing instructions executable by the processor to:
determine a time delta between a first time associated with the original POC and a second time associated with the related POC; and
perform the divergence assessment further based on the time delta.

20. The computer-readable medium of claim 15, further storing instructions executable by the processor to:
determine a time delta between a first time associated with the original POC and a second time associated with the related POC;
determine factor data associated with each of the original POC and the related POC, the factor data include at least location information, event data, and demographic information associated with the original POC and the related POC;
generate a training dataset including the factor data and the sentiment delta;
deliver the training dataset to a prediction model, wherein the prediction model is configured to be trained using the training dataset to generate predictive sentiment data for sample users; and
display the predictive sentiment data on the user interface.
